(19) United States
(12) Patent Application Publication
(10) Pub. No.: US 2025/0294630 A1
(43) Pub. Date: Sep. 18, 2025

(54) COMMUNICATION TECHNIQUE BETWEEN MULTI-LINK DEVICES

(71) Applicant: Nokia Technologies Oy, Espoo (FI)

(72) Inventors: Zhijie YANG, Shanghai (CN); Lorenzo GALATI GIORDANO, Stuttgart (DE); Mika KASSLIN, Espoo (FI)

(21) Appl. No.: 18/865,576

(22) PCT Filed: Jun. 14, 2022
(86) PCT No.: PCT/CN2022/098618

§ 371 Date: Nov. 13, 2024

(51) Int. Cl. H04W 76/15; H04W 68/00

(52) U.S. Cl. CPC H04W 76/15; H04W 68/00

(57) ABSTRACT

Various embodiments provide a method for multi-link communication. The device supporting multi-link communication receives a first notification message comprising AP unavailable information indicating one or more APs within a first AP device being unavailable from the first AP device supporting multi-link communication, and makes association decision with the first AP device based on the AP unavailable information.

### TECHNICAL FIELD

The teachings in accordance with example embodiments of present disclosure relate generally to wireless communication, for example WLAN communication.

### BACKGROUND

This section is intended to provide a background or context to example embodiments of the present disclosure. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Certain abbreviations that may be found in the description and/or in the Figures are herewith defined as follows:
AP Access Point
CAC Channel Available Check
DFS Dynamic Frequency Selection
ETSI European Telecommunications Standards Institute
FCC Federal Communications Commission
MLD Multi-link Device
NR Neighbor Report
RNR Reduced Neighbor Report
TBTT Target Beacon Transmission Time
UL/DL Uplink/Downlink
WLAN Wireless Local Area Networks

According to FCC and ETSI regulation specification, DFS channels can be further divided into weather channels and non-weather channels. The AP needs to mute itself and perform CAC for 1 minute on non-weather channels or 10 minutes on weather channels to detect radar signals before operating, so that the Wi-Fi signal won't interfere with radar signals on DFS channels. Otherwise, the AP needs to switch to another channel (DFS or non-DFS channel) if the radar signal is detected on the current DFS channel. According to the rule defined in ETSI specification, it is allowed that the AP switches back to the original DFS channel without CAC operation if there is no radar signal detected in the last operation, such behavior is also called as DFS channel re-entry operation.

802.11be defines a multi-link device architecture, that is, two MLDs set up connection among multiple links, and one MLD can transmit traffic to the other MLD on multiple set-up links simultaneously. As an example, an AP MLD and a non-AP MLD establish three links on 2.4 GHz, 5 GHz and 6 GHz, where they can transmit data simultaneously. Compared to the Wi-Fi STAs of the pre-802.11be architecture, the new multi-link architecture improves the throughput and reduces the latency significantly. Moreover, according to IEEE 802.11be, each AP MLD will contain a certain number of AP operating on one, or a multitude, of the available links. Similarly, each non-AP MLD may contain a certain number of STA, operating in one, or a multitude, of the available links.

### SUMMARY

The scope of protection sought for various embodiments of the present disclosure is set out by the independent claims. The embodiments and features, if any, described in this specification that do not fall under the scope of the independent claims are to be interpreted as examples useful for understanding various embodiments of the present disclosure.

According to a first aspect, various embodiments provide a method performed by a device supporting multi-link communication. The device supporting multi-link communication receives a first notification message comprising AP unavailable information indicating one or more APs within a first AP device being unavailable from the first AP device supporting multi-link communication, and makes association decision with the first AP device based on the AP unavailable information.

According to some embodiments, the AP unavailable information comprises channel available check (CAC) status related information indicating the one or more APs within the first AP device being in CAC state. According to some embodiments, the CAC status related information comprises an indication of at least one of APs within the first AP device being in CAC state and status information of each of the APs within the first AP device being in CAC state. According to some embodiments, the status information comprises the CAC duration and CAC remaining time of the each of the APs within the first AP device being in CAC state.

According to some embodiments, the device supporting multi-link communication further receives a second notification message without the AP unavailable information from the second AP device supporting multi-link communication. And the device supporting multi-link communication further makes association decision between the first AP device and second AP device based on the AP unavailable information.

According to some embodiments, the first AP device has a stronger signal strength than the second AP device, the device supporting multi-link communication associates with the second AP device for multi-link communication, and reassociates with the first AP device for multi-link communication in response to the one or more unavailable APs within the first AP device becoming available again.

According to some embodiments, the device supporting multi-link communication further reschedules traffic on the link of a first AP to be unavailable to one or more other links of APs within the same first AP device, and schedules the traffic back on the link of the first AP in response to the first AP becoming available again.

According to a second aspect, various embodiments provide a method performed by an AP device supporting multi-link communication. The AP device supporting multi-link communication transmits a first notification message comprising AP unavailable information indicating one or more APs within the AP device being unavailable to a device supporting multi-link communication.

According to some embodiments, the AP device supporting multi-link communication further associates with the device supporting multi-link communication for multi-link communication.

According to some embodiments, the AP device supporting multi-link communication further closes a link of an AP to be unavailable within the AP device, and reopens the link of the AP in response to the AP returning normal.

According to a third aspect, various embodiments provide a device supporting multi-link communication. The device comprises at least one processor and at least one memory storing instructions that, when executed by the at least one processor, cause the device at least to: receive, from a first AP device supporting multi-link communication, a first notification message comprising AP unavailable information indicating one or more APs within the first AP device being unavailable; and make association decision with the first AP device based on the AP unavailable information.

According to some embodiments, the device is further caused to: receive from a second AP device supporting multi-link communication, a second notification message without the AP unavailable information. And the device is further configured to make association decision between the first AP device and second AP device based on the AP unavailable information.

According to a fourth aspect, various embodiments provide an AP device supporting multi-link communication. The AP device supporting multi-link communication comprises at least one processor and at least one memory storing instructions that, when executed by the at least one processor, cause the AP device at least to: transmit a notification message comprising AP unavailable information indicating one or more APs within the AP device being unavailable to a device supporting multi-link communication.

According to a fifth aspect, various embodiments provide a system supporting multi-link communication. The system comprises a device and an AP device supporting multi-link communication. The device comprises at least one processor and at least one memory storing instructions that, when executed by the at least one processor, cause the device at least to: receive, from the first AP device supporting multi-link communication, a first notification message comprising AP unavailable information indicating one or more APs within the first AP device being unavailable; and make association decision with the first AP device based on the AP unavailable information. The first AP device supporting multi-link communication comprises at least one processor and at least one memory storing instructions that, when executed by the at least one processor, cause the first AP device at least to: transmit a notification message comprising AP unavailable information indicating one or more APs within the first AP device being unavailable to the device supporting multi-link communication.

### BRIEF DESCRIPTION OF THE DRAWINGS

The above and other aspects, features, and benefits of various embodiments of the present disclosure will become more fully apparent from the following detailed description with reference to the accompanying drawings, in which like reference signs are used to designate like or equivalent elements. The drawings are illustrated for facilitating better understanding of embodiments of the disclosure and are not necessarily drawn to scale, in which:

FIG. 1 shows the format of ML probe request frame in carrying out some example embodiments of the present disclosure;

FIG. 2(a) shows the format of RNR element; and FIG. 2(b) shows the format of TBTT information Header in the RNR element;

FIG. 3 shows the format of CAC element in carrying out some example embodiments of the present disclosure;

FIG. 4(a) shows the format of ML element in carrying out some example embodiments of the present disclosure; and FIG. 4(b) shows an example of the format of ML element with CAC element inserted in carrying out some example embodiments of the present disclosure;

FIG. 5 shows an example of a multi-link connection method that can be performed by devices supporting multi-link communication in accordance with some example embodiments of the present disclosure;

FIG. 6 exemplarily illustrates the multi-link setup procedure between two multi-link devices according to the embodiments of the present disclosure;

FIG. 7 shows an example of the multi-link connection procedure based on the CAC status related information delivered according to the embodiments of the present disclosure.

FIG. 8(a) exemplarily illustrates traffic rescheduling procedure between two multi-link connected devices before the AP MLD entering CAC state according to the embodiments of the present disclosure; and FIG. 8(b) exemplarily illustrates traffic rescheduling procedure between two multi-link connected devices after the AP MLD being out of CAC state according to the embodiments of the present disclosure.

### DETAILED EMBODIMENTS

Principle of the present disclosure will now be described with reference to some example embodiments. It is to be understood that these example embodiments are described only for the purpose of illustration and for helping those skilled in the art to understand and implement the present disclosure, without suggesting any limitation as to the scope of the disclosure. The embodiments described herein can be implemented in various manners which are not limited to the ones described below.

In the following description and claims, unless defined otherwise, all technical and scientific terms used herein have the same meaning as commonly understood by one of ordinary skills in the art to which this disclosure belongs.

The communication system and associated devices (e.g., AP MLD and non-AP MLD) typically operate in accordance with a given standard or specification which sets out what various entities associated with the system are permitted to do and how that should be achieved. Communication protocols and/or parameters which shall be used for the connection are also typically defined. One example of a communication system is WLAN communications system.

To the knowledge of the inventors, devices available prior to IEEE 802.11be, also referred to as legacy devices, were not able to discover or associate with an AP that was in CAC state.

According to IEEE 802.11be, the RNR element can be used to report the status and information of APs within the same AP MLD.

According to IEEE 802.11be draft, an AP is considered “discoverable” if its information is carried in the RNR element of a management frame transmitted by one of the other APs within the same AP MLD.

However, if one of the APs within an AP MLD is in CAC state, according to the current IEEE 802.11be draft specification, its information is not included in the RNR element. This may cause a missed detection of the link associated to the AP in CAC state during the discovery and association phase performed by a non-AP MLD.

The non-AP MLD that intends to set up multi-link connection with the AP MLD needs to know how many links the AP MLD has and the state of each link that operates on DFS channels, including the ones temporarily not discoverable as in CAC state.

During the association phase, the number of links that are established and thus can be used for the following transmission, may not include the link that is currently in CAC state, even if being in CAC state is a temporary condition. In fact, when the AP within an AP MLD is out of CAC state, in order to be discovered and added for MLO (multi-link operation), the non-AP MLD and the AP MLD need to go through a completely new association procedure.

A non-AP MLD demanding a high number of links to support e.g., high throughput and/or low latency applications may decide not to connect with an AP MLD which may have a subset of APs operating in CAC state, However, this is only a temporary condition which should be known by the non-AP MLD to trigger a more informed decision during the association procedure.

The example embodiments of the present disclosure introduce a new signaling that carries CAC status related information of other APs within a same AP MLD of reporting AP to inform the non-AP MLD that some of the APs are operating on DFS channels.

Certain notification messages such as Beacon frame, probe response frame or other management frames, can be used to carry information of other APs within the same AP MLD in NR element or RNR element or Basic variant ML element. In an AP MLD, an AP which is sending such certain notification messages can be referred to as reporting AP, and other APs within the same AP MLD of which the status and information is reported by the reporting AP can be referred to as reported AP. According to the rule defined by 802.11be draft, the reported AP information like Operating Class, channel number, MLD ID (identification for each AP MLD for co-host multiple AP MLD devices), Link ID (identification for each AP within an AP MLD), etc. would be carried in RNR element in the Management frame like Beacon frame transmitted by the reporting AP within same AP MLD.

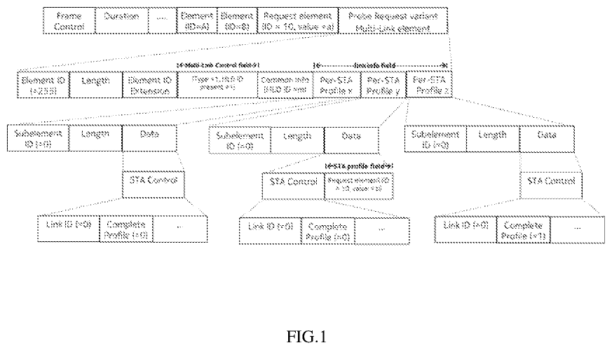

To meet the requirement that non-AP MLD may request information for the reported APs affiliated with same AP MLD as the reporting AP without performing active/passive scan on each of the reported AP's operating channel, a new type of probe request/response frame named ML probe request/response frame is defined in 802.11be draft 1.1. The ML probe request/response frames facilitate the non-AP MLD to gather the required information of other APs affiliated with same AP MLD on only one of the AP's operating channels (ML scan operation). FIG. 1 depicts the format of ML probe request frame, in which the non-AP MLD intends to retrieve partial information of AP-x, special information of AP-y and all information of AP-z as indicated in per-STA profile x, per-STA profile y, and per-STA profile z.

According to embodiments of the present disclosure, an AP MLD may transmit a Beacon frame or other management frames periodically, and non-AP MLD within the coverage of the AP MLD may receive such frames carrying CAC status related information of other AP within this AP MLD on an AP's operating channel. Alternatively, a non-AP MLD may send a ML probe request frame to an AP MLD to request certain AP's information, and the AP MLD may return a ML probe response frame carrying CAC status related information of other AP within this AP MLD which is currently in CAC state.

In order to transmit the CAC status related information of other AP within this AP MLD which is currently in CAC state on an AP's operating channel, embodiments of the present disclosure propose to redefine the RNR element and ML element carried in the Beacon frame, ML probe response frame or other management frames. The CAC status related information comprises indication of at least one of other APs within the same AP device of the reporting AP being in CAC state and status information of each of the other APs within the same AP device of the reporting AP being in CAC state. And the status information comprises the CAC duration and CAC remaining time of each of the other APs within the same AP device of the reporting AP being in CAC state.

According to embodiments of the present disclosure, the RNR element is redefined to indicate whether there is at least one of other APs within the same AP device of the reporting AP currently in CAC state, and CAC element is newly set in the ML element to carry the CAC duration and CAC remaining time of each of the other APs within the same AP device of the reporting AP being in CAC state.

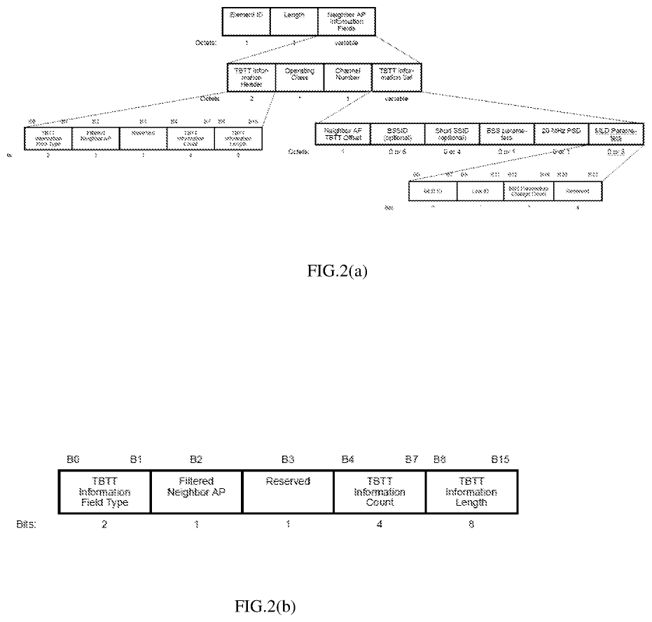

A non-AP STA may know the basic information like operating channel, SSID (service set identifier), etc. of the other APs within an AP MLD via RNR element which is contained in Beacon frame, probe response frame or other management frames transmitted by one of the APs within the AP MLD. As shown in FIG. 2(a)), in RNR element, each neighbor AP's information fields comprise such as: TBTT information Header, Operating Class, Channel Number and TBTT information Set subfield. According to the baseline rule, with reference to FIG. 2(b), the TBTT Information Field Type subfield in TBTT information Header subfield identifies, together with the TBTT Information Length subfield, the format of the TBTT Information field. And it is set to 0, while values 1, 2, and 3 are reserved.

When a non-AP STA that receives a Neighbor AP Information field with an unrecognized TBTT Information Field Type subfield, i.e., a value different than 0, it shall ignore the remainder of the RNR element.

According to embodiments of the present disclosure, the TBTT Information Field Type can be set to a certain reserved value other than 0, such as one of 1, 2, and 3 to inform the received non-AP MLD that there is one or more APs within the AP MLD in CAC state. In one embodiment, when a non-AP MLD receives a Beacon frame carrying RNR element with TBTT Information Field Type “1”, the non-AP MLD would decode the RNR information knowing that some AP within the AP MLD is currently in CAC state.

It is to be noted that, Information associated to APs that are in CAC state are appended at the end of the RNR element, so as to prevent any decoding issues for legacy operations.

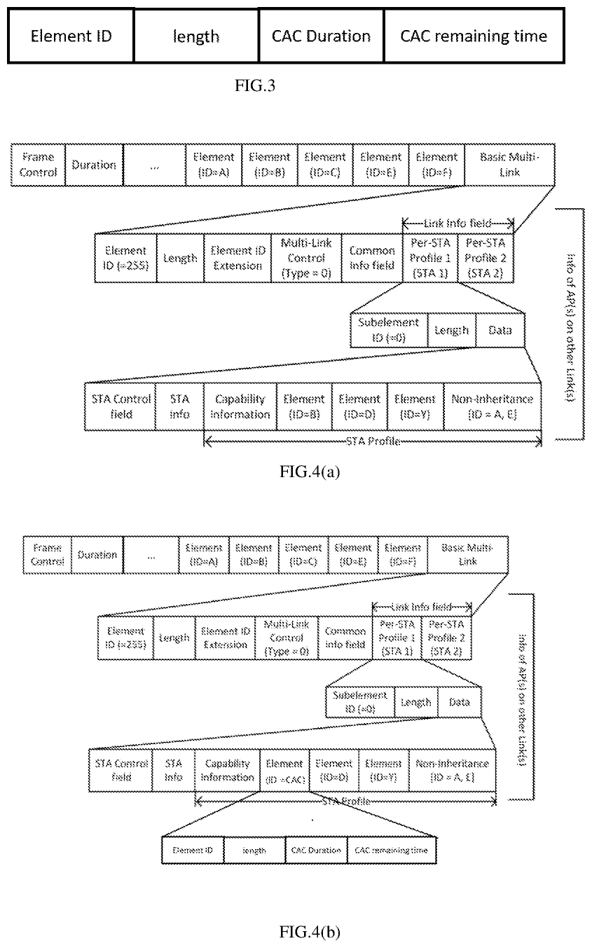

According to embodiments of the present disclosure, referring to FIG. 3, the CAC element is consisted by Element ID, Length, CAC Duration and CAC remaining time subfields. The explanation of each subfield is shown as bellow:
the Element ID subfield is set with a unique element ID to identify CAC element;
the Length subfield is set to the length of whole CAC element;
the CAC Duration subfield is set to the total CAC duration on current DFS channel in minutes unit, e.g., 1 minute or 10 minutes;
the CAC remaining time subfield is set to the remaining time of CAC state on current DFS channel in seconds unit. The initial value is equal to the value in CAC duration subfield, and it is decreased by 1 after each second passes. And it means no radar signal detected till the value in CAC remaining time subfield becomes 0.

According to embodiments of the present disclosure, with reference to FIG. 4, the CAC element can be used as one of the Element available in the per-STA profile of ML element once the corresponding AP within AP MLD is in CAC state.

FIG. 4(a) shows an example of the format of ML element. The Element available such as Element (ID=B), Element (ID=D), and Element (ID=Y), in the STA profile can be used to carry the CAC element of FIG. 3, and FIG. 4(b) shows an example of the format of ML element with CAC element inserted.

According to embodiments of the present disclosure, a first AP MLD transmits a first notification message comprising AP unavailable information indicating one or more APs within the first AP MLD being unavailable to a non-AP MLD. Then the non-AP MLD makes association decision with the first AP MLD based on the AP unavailable information.

The AP unavailable information comprises CAC status related information indicating the one or more APs within the first AP MLD being in CAC state. The CAC status related information comprises an indication of at least one of APs within the first AP MLD being in CAC state and status information of each of the APs within the first AP MLD being in CAC state. According to embodiments of the present disclosure, as shown in FIG. 2(b), the indication for APs within the first AP MLD being in CAC state can be included in the TBTT Information field with value “1” in the RNR element. And the status information comprises the CAC duration and CAC remaining time of the each of the APs within the first AP MLD being in CAC state. According to embodiments of the present disclosure, as shown in FIGS. 3 and 4, the status information of each AP within the first AP MLD being in CAC state can be included in the CAC element of the ML element.

According to embodiments of the present disclosure, when there is only one first AP MLD transmitting a first notification message comprising AP unavailable information indicating one or more APs within the first AP MLD being unavailable to a non-AP MLD, the non-AP MLD makes a decision to associate with the first AP MLD based on the AP unavailable information.

According to embodiments of the present disclosure, when there is more than one first AP MLD transmitting a first notification message comprising AP unavailable information indicating one or more APs within the first AP MLD being unavailable to a non-AP MLD, the non-AP MLD can select one first AP MLD from these transmitting first AP MLDs based on the AP unavailable information such as the numbers of unavailable links and then associate with the selected first AP MLD.

According to embodiments of the present disclosure, there is a first AP MLD transmitting a first notification message and a second AP MLD transmitting a second notification message to the non-AP MLD. The first notification message comprises AP unavailable information indicating one or more APs within the first AP MLD being unavailable. The second notification message does not have such AP unavailable information as all the APs within the second AP MLD are available. Thus the non-AP MLD may select the second AP MLD for multi-link connection based on the AP unavailable information.

Alternatively, in an embodiment, although the second AP MLD may have a lower signal strength than the first AP MLD, the non-AP MLD may select the second AP MLD for multi-link connection first since the first AP MLD has one or more unavailable APs currently. When the unavailable APs within the first AP MLD returns normal based on the AP unavailable information, the non-AP MLD can disconnect with the second AP MLD and reassociate with the first AP MLD.

According to embodiments of the present disclosure, in the discovery phase, a non-AP MLD can know the CAC status of APs within the same AP MLD including CAC duration and CAC remaining time of each AP in CAC state. Then the non-AP MLD can make association decision on whether to set up multi-link connections with this AP MLD in the association phase.

FIG. 5 shows an example of the multi-link connection procedure between two communication devices supporting multi-link communication. Typically, the two devices can be a non-AP MLD and an AP MLD. For easy reading and illustrating, here below the non-AP MLD and AP MLD are used for exemplarily describing how the multi-link connection is set up.

As shown in FIG. 5, at step 510, the AP MLD 501 periodically transmits a Beacon frame carrying information of APs within the AP MLD 501. And the non-AP MLD 502 receives the Beacon frame and extracts the number of links of the AP MLD 501 from the Beacon frame.

For further knowledge of APs in CAC state, at step 520, the non-AP MLD 502 sends a ML probe request frame to the AP MLD 501 to acquire certain information of other APs within the AP MLD 501.

It is to be noted that, AP in CAC state is merely an example of unavailable AP according to the embodiments of the present disclosure, the CAC status can be delivered in the CAC element, and other examples of unavailable AP can be known in the other specific or non-specific element, which is not excluded or limited in the present disclosure.

At step 530, the AP MLD 501 returns a ML probe response frame informing the non-AP MLD 502 the CAC status related information of one or more APs within the AP MLD 501. The CAC status related information comprises indication of at least one of APs within the AP MLD 501 being in CAC state and status information of each of the APs within the AP MLD 501 being in CAC state.

At step 540, the non-AP MLD makes a decision on whether associating with the AP MLD 501, based on the number of links available in the AP MLD 501, the bandwidth of each available link, and the duration and remaining time of links in CAC state.

At step 550, the non-AP MLD 502 sends an association request frame to the AP MLD 501 if the non-AP MLD 502 decides to connect with the AP MLD 501.

At step 560, the AP MLD 501 returns an association response frame to the non-AP MLD 502. The multi-link connection between the non-AP MLD 502 and the AP MLD 501 completes.

After gathering all the expected information of AP within same AP MLD 501 via ML probe request/response frame exchange, the non-AP MLD 502 can set up multi-link connection with the AP MLD 501.

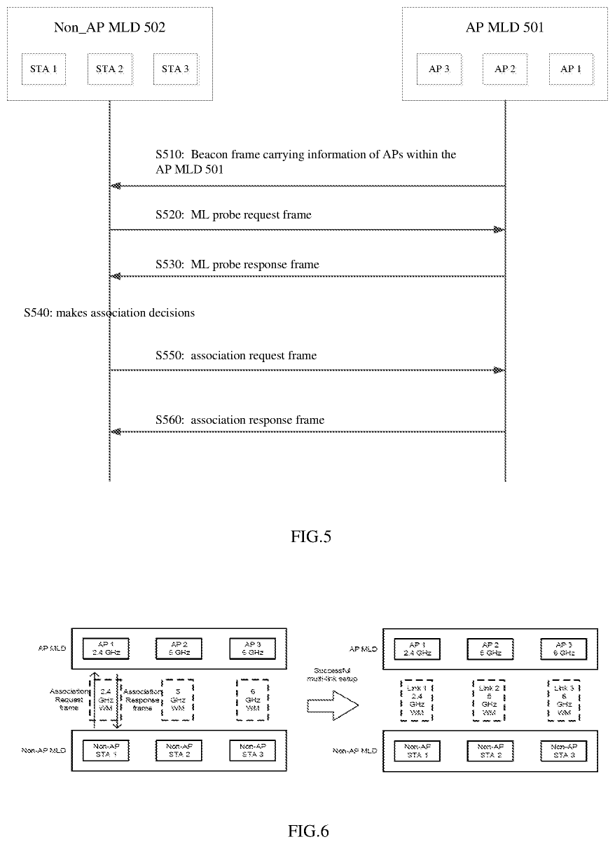

As an example, shown in FIG. 6, three links on 2.4 GHz, 5 GHz and 6 GHz can be established for simultaneous communication between the AP MLD and non-AP MLD after MLD (re)setup as described in section 35.3.5 of 802.11be specification. Compared to the legacy 802.11 architecture, the new multi-link architecture proposed by the embodiments of present disclosure would improve data throughput and reduces transmission latency significantly.

Since the notification messages from the AP MLD may inform the non-AP MLD the CAC status related information of APs within this AP MLD, the non-AP MLD can make an informed decision such as still associating with the current AP MLD or turn to another AP MLD.

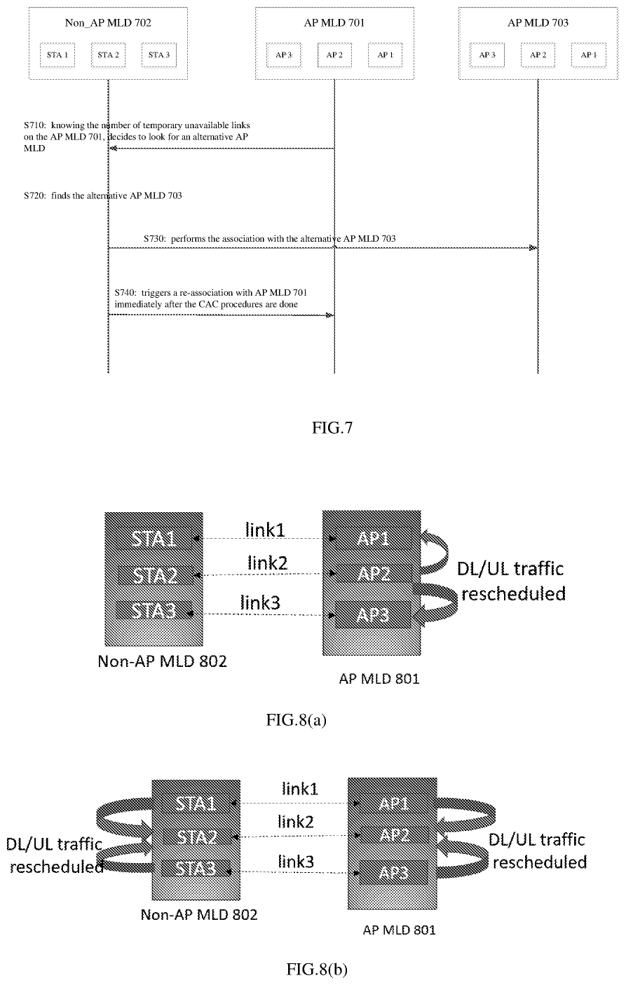

FIG. 7 shows an example of the multi-link connection procedure based on the CAC status related information delivered according to the embodiments of the present disclosure. A non-AP MLD 702 demanding a high number of links to support e.g., high throughput and/or low latency applications may decide not to associate with AP MLD 701 which has a subset of APs busy in CAC operation on DFS channels. Since the non-AP MLD 702 may also receive Beacon frame from another AP MLD 703, the AP MLD 703 may be a substitute AP MLD that the non-AP MLD 702 can turn to.

At step 710, the non-AP MLD 702 knows the number of temporary unavailable links on the AP MLD 701 providing the highest signal strength, it could decide to look for an alternative AP MLD, even if further away and with worst received signal strength.

At step 720, the non-AP MLD 702 finds the alternative AP MLD 703, the non-AP MLD 702 needs to evaluate whether its expected throughput/delay could be improved by triggering the new association, compared with the decision to associate with the AP MLD 701 of stronger signal but with a set of links temporarily unavailable as busy in CAC operations.

At step 730, if the evaluation is positive, the non-AP MLD 702 performs the association with the alternative AP MLD 703. This evaluation can be performed by comparing the number of available links and their correspondent bandwidths as this could give an indication of the expected theoretical throughput and latency.

At step 740, the non-AP MLD 702 knows the remaining time till the links would become again available in the stronger AP MLD 701, the non-AP MLD 702 could trigger a reassociation to AP MLD 701 immediately after the CAC procedures (all or part of it) are done on its links. A second evaluation may be triggered to decide whether the expected throughput/delay could be improved by performing the reassociation to AP MLD 701. In this way, the non-AP MLD 702 could maximize its benefits in terms of number of available links and targeted performance by choosing the sub-optimal AP MLD 703 only for the time when this operation provides an advantage. This amount of time is linked to the time when the links of the AP MLD 701 are in CAC state.

FIGS. 8(a) and 8(b) exemplarily illustrates traffic rescheduling procedure between two multi-link connected devices before CAC state and out of CAC state according to the embodiments of the present disclosure.

Assuming the non-AP MLD 802 remains associated to the AP MLD 801 which operates in DFS channels, the AP MLD 801 can close the link(s) before its APs enter in CAC state and, thus, schedules the corresponding UL/DL traffic to other links to reduce the possible resulting latency. According to embodiments of the present disclosure, rescheduling the UL/DL traffic back to the affected link(s) immediately after they are supposed to be reopened, leveraging the information on the remaining time in CAC state is made available by the CAC status related information informing procedure.

As shown in FIGS. 8(a) and (b), the AP MLD 801 reschedules the DL/UL traffic with the non-AP MLD 802 before the AP (e.g., AP2) enters in CAC state and becomes unavailable.

The non-AP MLD 802 starts to prepare rescheduled DL/UL traffic to be delivered to the effected link (e.g., link2) as soon as it becomes again available. This operation is based on the novel introduced information on the remaining time in CAC state.

The AP MLD 801 closes the link (e.g., link2) and operates the APs in CAC state after switching to the DFS channel.

The AP MLD 801 and the non-AP MLD 802 schedule and transmit DL/UL traffic once the link (link2) becomes available and is reopened by both sides based on the CAC remaining time.

In general, various embodiments may be implemented in hardware or special purpose circuitry, software, logic or any combination thereof. For example, some aspects may be implemented in hardware, while other aspects may be implemented in firmware or software which may be executed by a controller, microprocessor or other computing device, although the present disclosure is not limited thereto. While various aspects of the present disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

For example, embodiments of the present disclosures may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

As used in this disclosure, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in the present disclosure, including in any claims. As a further example, as used in the present disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The device may include one or more processors, one or more memories, and one or more network interfaces. The one or more memories may store computer program instructions. The one or more memories and the computer program instructions may be configured to, with the one or more processors, cause the device to perform one or more operations which may be needed to support the operations in accordance with some example embodiments of the present disclosure.

The word “example” is used herein to mean “serving as an example, instance, or illustration.” Any embodiment described herein as “example” is not necessarily to be construed as preferred or advantageous over other embodiments. All of the embodiments described in this Detailed Description are example embodiments provided to enable persons skilled in the art to make or use the present disclosure and not to limit the scope of the present disclosure which is defined by the claims.

Various modifications and adaptations to the example embodiments provided herein may become apparent to those skilled in the relevant arts in view of the foregoing description, when read in conjunction with the accompanying drawings and the appended claims. However, all such and similar modifications of the teachings of this present disclosure will still fall within the scope of this present disclosure.

It should be noted that the terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and/or printed electrical connections, as well as by the use of electromagnetic energy, such as electromagnetic energy having wavelengths in the radio frequency region, the microwave region and the optical (both visible and invisible) region, as several non-limiting and non-exhaustive examples.

Furthermore, some of the features of some example embodiments of this present disclosure could be used to advantage without the corresponding use of other features. As such, the foregoing description should be considered as merely illustrative of the principles of the present disclosure, and not in limitation thereof.

1-17. (canceled)

18. A method comprising:
receiving, by a device supporting multi-link communication, from a first access point (AP) device supporting multi-link communication, a first notification message comprising AP unavailable information indicating one or more APs within the first AP device being unavailable; and
making, by the device supporting multi-link communication, association decision with the first AP device based on the AP unavailable information.

19. The method of claim 18, wherein the AP unavailable information comprises channel available check (CAC) status related information indicating the one or more APs within the first AP device being in CAC state.

20. The method of claim 19, wherein the CAC status related information comprises an indication of at least one of APs within the first AP device being in CAC state and status information of each of the APs within the first AP device being in CAC state.

21. The method of claim 20, wherein the status information comprises the CAC duration and CAC remaining time of the each of the APs within the first AP device being in CAC state.

22. The method of claim 20, wherein the indication of at least one of APs within the first AP device being in CAC state is included in the TBTT Information field with a predefined value in the RNR element, and the status information of each of the APs within the first AP device being in CAC state is included in the CAC element of the ML element.

23. The method of claim 22, wherein information associated to each of the APs within the first AP device being in CAC state are appended at the end of the RNR element.

24. The method of claim 18, wherein the method further comprises:
receiving, from a second AP device supporting multi-link communication, a second notification message without the AP unavailable information;
wherein making association decision further comprises:
making, by the device supporting multi-link communication, association decision between the first AP device and second AP device based on the AP unavailable information.

25. The method of claim 24, wherein the first AP device has a stronger signal strength than the second AP device;
wherein making association decision further comprises:
association, by the device supporting multi-link communication, with the second AP device for multi-link communication; and
in response to the one or more unavailable APs within the first AP device becoming available again, reassociating by the device supporting multi-link communication, with the first AP device for multi-link communication.

26. The method of claim 18, wherein the method further comprises:
rescheduling, by the device supporting multi-link communication, traffic on the link of a first AP to be unavailable to one or more other links of APs within the same first AP device; and
in response to the first AP becoming available again, scheduling by the device supporting multi-link communication, the traffic back on the link of the first AP.

27. A method comprising:
transmitting, by an access point (AP) device supporting multi-link communication, a first notification message comprising AP unavailable information indicating one or more APs within the AP device being unavailable to a device supporting multi-link communication.

28. The method of claim 27, wherein the method further comprises:
associating, by the AP device supporting multi-link communication, with the device supporting multi-link communication for multi-link communication.

29. The method of claim 27, wherein the AP unavailable information comprises channel available check (CAC) status related information indicating the one or more APs within the AP device being in CAC state.

30. The method of claim 27, wherein the method further comprises:
closing, by the AP device supporting multi-link communication, a link of an AP to be unavailable within the AP device; and
in response to the AP becoming available, reopening by the AP device supporting multi-link communication, the link of the AP.

31. A device comprising:
at least one processor; and
at least one memory storing instructions that, when executed by the at least one processor, cause the device at least to:
receive, from a first access point (AP) device supporting multi-link communication, a first notification message comprising AP unavailable information indicating one or more APs within the first AP device being unavailable; and
make association decision with the first AP device based on the AP unavailable information.

32. The device of claim 31, wherein the device is further configured to:
receive, from a second AP device supporting multi-link communication, a second notification message without the AP unavailable information;
wherein make association decision further comprises:
make association decision between the first AP device and second AP device based on the AP unavailable information.

33. The device of claim 31, wherein the AP unavailable information comprises channel available check (CAC) status related information indicating the one or more APs within the first AP device being in CAC state.

34. The device of claim 31, wherein the CAC status related information comprises an indication of at least one of APs within the first AP device being in CAC state and status information of each of the APs within the first AP device being in CAC state.

35. The device of claim 31, wherein the status information comprises the CAC duration and CAC remaining time of the each of the APs within the first AP device being in CAC state.

36. An access point (AP) device comprising:
at least one processor; and
at least one memory storing instructions that, when executed by the at least one processor, cause the AP device at least to:
transmit, to a device supporting multi-link communication, a notification message comprising AP unavailable information indicating one or more APs within the AP device being unavailable.

37. A system comprising:
a device comprising:
at least one processor; and
at least one memory storing instructions that, when executed by the at least one processor, cause the device at least to:
receive, from a first access point (AP) device supporting multi-link communication, a first notification message comprising AP unavailable information indicating one or more APs within the first AP device being unavailable; and
make association decision with the first AP device based on the AP unavailable information the first AP device comprising:
at least one processor; and
at least one memory storing instructions that, when executed by the at least one processor, cause the first AP device at least to:
transmit, to the device, a first notification message comprising AP unavailable information indicating one or more APs within the first AP device being unavailable.
